(19) United States
(12) Patent Application Publication
(10) Pub. No.: US 2020/0235968 A1
(43) Pub. Date: Jul. 23, 2020

(54) COMMUNICATION DEVICE AND METHOD FOR RECEIVING DATA VIA A RADIO SIGNAL

(71) Applicant: Infineon Technologies AG, Neubiberg (DE)

(72) Inventor: Raimondo Luzzi, Graz (AT)

(21) Appl. No.: 16/738,227

(22) Filed: Jan. 9, 2020

(30) Foreign Application Priority Data
Jan. 23, 2019 (DE) 102019101621.5

(51) Int. Cl. H04L 27/227; H04L 27/38; H04L 27/26

(52) U.S. Cl. CPC H04L 27/2271; H04L 27/2613; H04L 27/3881

(57) ABSTRACT

A communication device having a radio receiver configured to receive a radio signal, a sampling circuit configured to sample the radio signal to generate a sequence of digital sampling values of the radio signal, a correlator configured to correlate the sequence of digital sampling values with each of a plurality of sequences of reference signal values, wherein each sequence of reference signal values corresponds a respective radio communication technology of a plurality of radio communication technologies, a controller configured to select a radio communication technology of the plurality of radio communication technologies based on the results of the correlation, and a data recovery circuit configured to demodulate and decode the radio signal according to the selected radio communication technology.

### TECHNICAL FIELD

The present disclosure relates to communication devices and methods for receiving data via a radio signal.

### BACKGROUND

There exist multiple contactless proximity or vicinity communication types, among them types according to near-field communication (NFC) which may be used for communication between a communication device and readers of the infrastructure, specifically, for example, ISO/IEC 14443 Type A, ISO/IEC 14443 Type B and ISO 18092 FeliCa (Felicity Card). Accordingly, there may be infrastructures (e.g. chip card readers) which operate according to different communication types. Since it is desirable to be able to use the same communication device (e.g. the same smart-card) with readers operating according to different communication types, approaches are desirable that allow a communication device to determine a communication type.

### SUMMARY

According to one embodiment, a communication device is provided including a radio receiver configured to receive a radio signal, a sampling circuit configured to sample the radio signal to generate a sequence of digital sampling values of the radio signal, a correlator configured to correlate the sequence of digital sampling values with each of a plurality of sequences of reference signal values, wherein each sequence of reference signal values corresponds with a respective radio communication technology of a plurality of radio communication technologies, a controller configured to select a radio communication technology of the plurality of radio communication technologies based on the results of the correlation and a data recovery circuit configured to demodulate and decode the radio signal according to the selected radio communication technology.

According to a further embodiment, a method for receiving data via a radio signal is provided including receiving a radio signal, sampling the radio signal to generate a sequence of digital sampling values of the radio signal, correlating the sequence of digital sampling values with each of a plurality of sequences of reference signal values, wherein each sequence of reference signal values corresponds with a respective radio communication technology of a plurality of radio communication technologies, selecting a radio communication technology of the plurality of radio communication technologies based on the results of the correlation and demodulating and decoding the radio signal according to the selected radio communication technology.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication arrangement including a reader and a chip card.

FIG. 2 shows a communication arrangement including a reader and an ASK (amplitude shift keying) digital receiver.

FIG. 3 shows the digital envelope for various commands.

FIG. 4 shows a communication arrangement including a reader and an ASK digital receiver having a correlator for automatic communication type detection.

FIG. 5 shows examples of reference sequences used by the correlator to determine a communication type.

FIG. 6 shows a correlator according to an embodiment.

FIG. 7 shows a communication device according to an embodiment.

FIG. 8 shows a flow diagram illustrating a method for receiving data via a radio signal.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

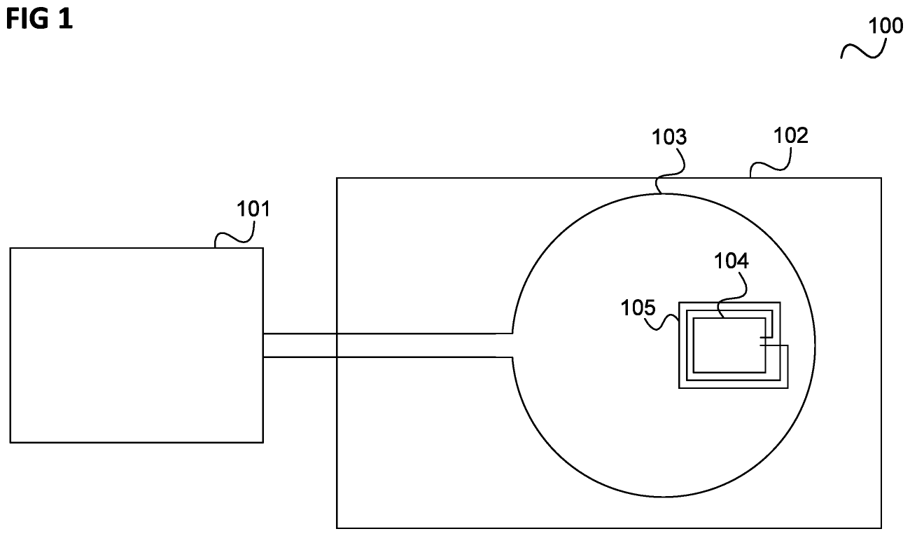

FIG. 1 shows a communication arrangement 100 including a reader 101 and a chip card 102. The reader includes an antenna 103 which is for example arranged in a housing onto which the chip card 102 is placed. The chip card 102 includes a chip card module 104 and a chip card antenna 105.

The reader 101 and the chip card module 104 may communicate by means of the antennas 103, 105.

It should be noted that the chip card with a chip card module is only an example and may also be a contactless transponder 104 such as an RFID (radio-frequency identification) tag or a smartphone supporting near-field communication (NFC).

For example, the chip card module (or transponder) 104 and the reader 101 may support communication according to ISO/IEC 14443.

A contactless transponder (e.g. corresponding to chip card 104) according to ISO/IEC 14443 communicates with the reader (e.g. reader 101) using amplitude shift keying (ASK) modulation. Two different types are supported:
Type-A with 100% modulation index and modified Miller coding for the data at baud rates from 106 kbaud/s to 848 kbaud/s
Type-B with 10% (nominal) modulation index and NRZ (Non Return to Zero) coding for the data at baud rates from 106 kbaud/s to 6.8 Mbaud/s

In addition, transponders according to the Japanese standard for proximity cards “FeliCa” communicate with the reader using ASK with 10% (nominal) and Manchester data coding (reverse/obverse) at baud rates 212 kbaud/s or 424 kbaud/s.

A reader 101 polls for a transponder 104 by sending standard commands:
Type A readers: REQA/WUPA at 106 kbaud/s
Type B readers: REQB/WUPB at 106 kbaud/s
FeliCa readers: REQ at 212 kbaud/s or at 424 kbaud/s

It may be desirable that a transponder is able to determine itself which proximity or vicinity communication type (e.g. NFC type) is used by a reader such that a user can use it conveniently with different readers.

Accordingly, according to various embodiments, a circuit and an algorithm are provided which allow to automatically detect which communication type is sent by a reader in a way that even the very first command is received correctly by a transponder.

It should be noted that for such an automatic type selection one or more demodulators may be used to extract a binary signal from the analog envelope of a received signal by detecting its edges. The type selection may then be performed by processing the binary signal, either by using several decoders for the different communication types or sampling the binary signal at the beginning of the transmission to determine the correct communication type as fast as possible. However, using a plurality of demodulators and/or decoders costs area and power and, in addition, in the binary signal after demodulation information useful to detect the transmitted type is lost (e.g. modulation depth, edge shapes, . . . ).

In contrast, according to various embodiments, the digitalized analog envelope (also referred to as digital envelope) of a received signal (before demodulation and decoding) is used for automatic type selection. This is explained in the following in more detail.

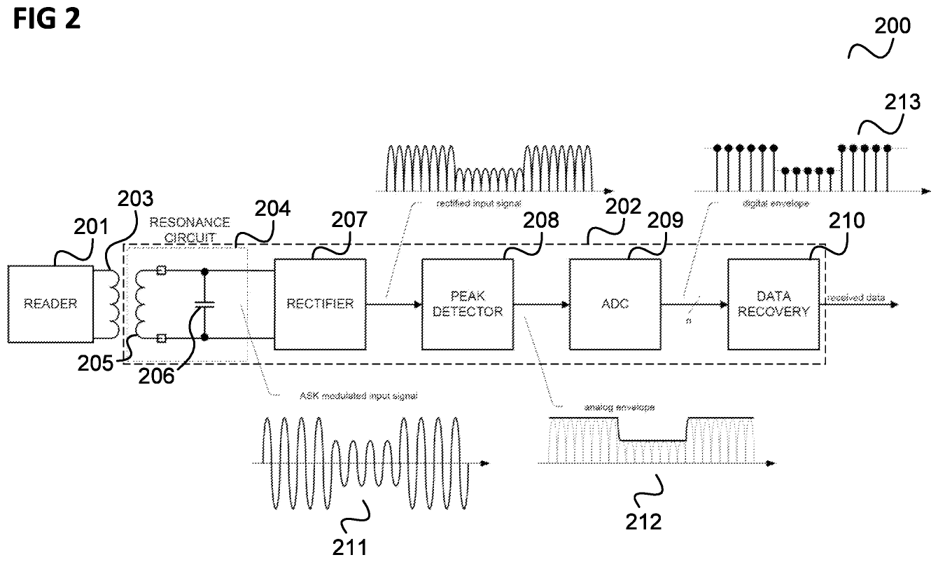

FIG. 2 shows a communication arrangement 200 including a reader 201 (e.g. corresponding to the reader 101) and an ASK digital receiver 202 (e.g. corresponding to the chip card module 104).

The reader 201 includes a reader antenna 203 via which it sends an (ASK-)modulated radio signal to the receiver 202. The receiver includes a resonance circuit 204 (including an antenna 205 and a capacity 206 in parallel to the antenna 205) which receives the modulated radio signal as a modulated input signal 211. The modulated input signal 211 is rectified by means of a rectifier 207 and its analog envelope 212 is extracted by means of a peak detector 208. The analog envelope 212 is digitalized by means of an analog-to-digital converter 209 to a digital envelope 213 and a data recovery module 210 extracts the transmitted data based on a data recovery algorithm.

For example, in the digital ASK receiver 202, the analog envelope 212 is digitalized by means of an n-bit ADC running at a certain sampling frequency (e.g. 2×13.56 MHz or lower). The data sequence generated by the ADC, adc[i], i.e. the digital envelope, is used in a data recovery algorithm to extract the transmitted data.

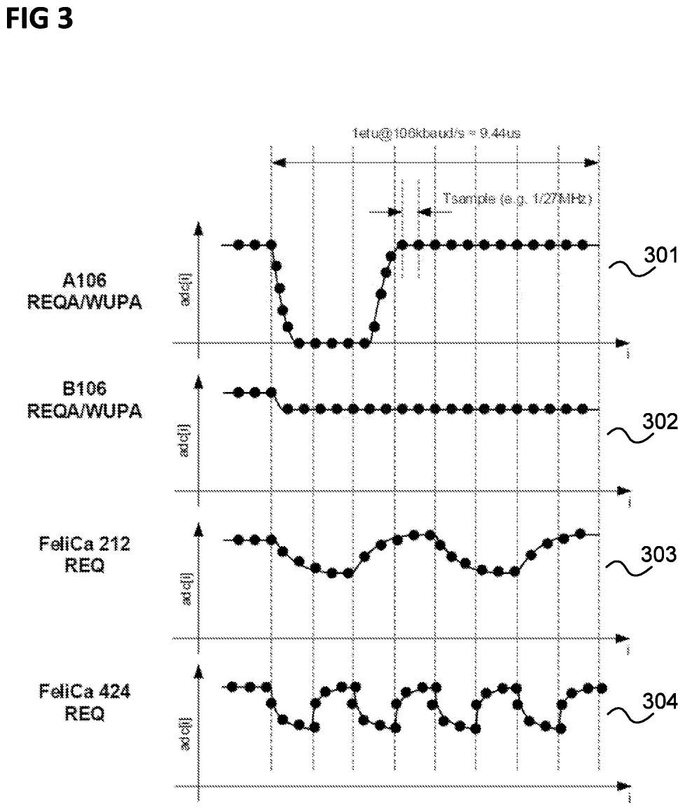

FIG. 3 shows the digital envelope for various commands.

Specifically, adc[i] is shown for e.g. the first etu (elementary time unit) for 106 kbaud/s (ca. 9.44 us) of a ISO/IEC 14443 Type A (first graph 301), Type B (second graph 302) and FeliCa 212 kpbs (third graph 303) and FeliCa 424 kpbs (fourth graph 304) polling command. It should be noted that transmitted data in the four cases in FIG. 3 (REQA/WUPA, REQB/WUPB, REQ F212, REQ F424) are constant for at least 1 etu at 106 kbaud/s.

Each graph 301, 302, 303 shows the digital envelope by means of a sequence of digital values (marked by the bold points) which may correspond to sampling values. Time increases from left to right (corresponding to a time or sample index ‘i’). Two consecutive digital values are separated by a sampling time Tsample, e.g. 1/27 Mhz. The digital values are referred to as adc[i] and their value increases in accordance with the vertical axis from bottom to top.

The waveforms shown are only examples and the analog characteristics of the signal can change in practical application (different modulation indexes, falling/rising times, overshoots/undershoots, humps, etc.).

Assuming a sampling frequency of 2×13.56 MHz and 1 etu at 106 kbaud/s, adc[i] is a sequence of 256 n-bit samples (with e.g. n=6).

According to various embodiments, a receiver correlates the digital envelope 213 with reference sequences for various communication technologies, e.g. Type A, FeliCa 212 (i.e. 212 kbps) and FeliCa 424 (i.e. 424 kbps).

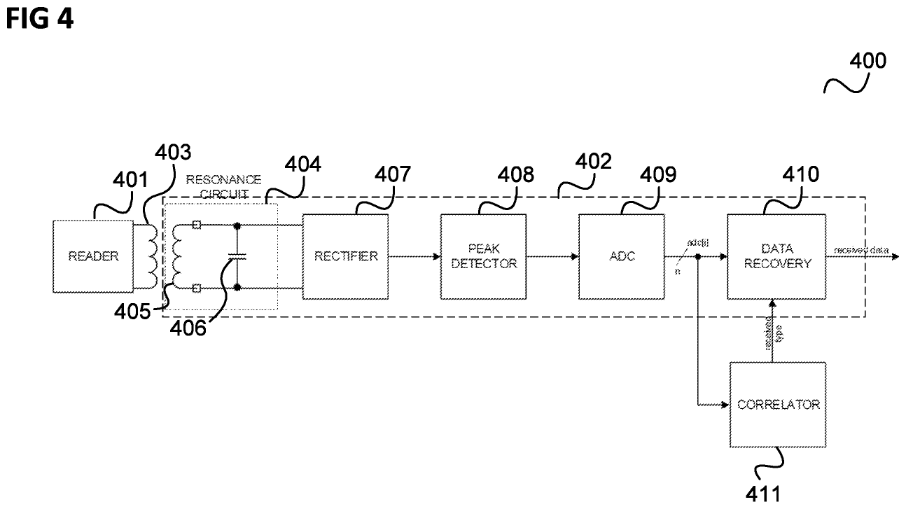

FIG. 4 shows a communication arrangement 400 including a reader 401 (e.g. corresponding to the reader 101) and an ASK digital receiver 402 (e.g. corresponding to the chip card module 104).

Similarly to FIG. 2, the reader 401 includes a reader antenna 403 via which it sends an (ASK-)modulated radio signal to the receiver 402. The receiver includes a resonance circuit 404 (including an antenna 405 and a capacity 406 in parallel to the antenna 405) which receives the modulated radio signal as a modulated input signal. The modulated input signal is rectified by means of a rectifier 407 and its analog envelope is extracted by means of a peak detector 408. The analog envelope is digitalized by means of an analog-to-digital converter 409 to a digital envelope and a data recovery module 410 extracts the transmitted data based on a data recovery algorithm.

In addition to the components corresponding to FIG. 2, a correlator 411 is provided which is supplied with the digital envelope adc[i] and which determines the communication type of the received radio signal which it indicates to the data recovery module 410. The data recovery module 410 performs demodulation and decoding and may thus correspondingly include a demodulator and a decoder for each of a plurality of (possible) communication types (i.e. for each of a plurality of supported communication technologies, e.g. near-field communication technologies).

For example, at the beginning of a new communication, the data recovery module 410 (e.g. performing a data recovery algorithm) waits for e.g. one etu at 106 kbaud/s for the correlator 411 to decide which communication type is going to be received. After the decision, the data recovery module is configured to receive the correct type and the data reception starts from the second etu.

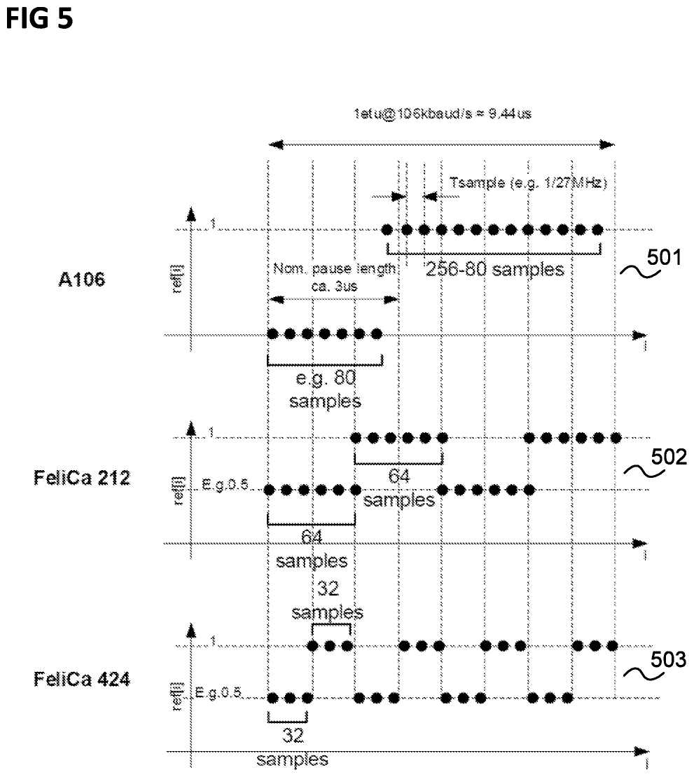

FIG. 5 shows examples of reference sequences used by the correlator 411 to determine the communication type.

Specifically, FIG. 5 shows a reference sequence for ISO/IEC 14443 Type A (shown in first graph 501, and referred to as A106), FeliCa 212kpbs (shown in second graph 502 and referred to as F212) and FeliCa 424 kpbs (shown in third graph 503 and referred to as F424).

Similarly to FIG. 3, each graph 501, 502, 503 shows a sequence of digital values (marked by the bold points) which may correspond to ideal sampling values of the radio signal waveform of a polling command. Time increases from left to right (corresponding to a time or sample index T). Two consecutive digital values are separated by a sampling time Tsample, e.g. 1/27 Mhz. The digital values are referred to as adc[i] and their value increases in accordance with the vertical axis from bottom to top.

The correlator 411 may for example correlate three 256-samples 2-valued reference sequences illustrated in FIG. 5 with the adc[i] digital envelope (which is the correlator's input sequence) by calculating the following three correlation values for ISO/IEC Type A, FeliCa 212 and FeliCa 424 respectively:

$$\begin{matrix}corr\_A106 = {max}_{j = 0 …255} {\sum }_{i = 1}^{256} adc [ i ] \cdot ref\_A106 [ i - j ] & ( 1 ) \\ corr\_F212 = {max}_{j = 0 …255} {\sum }_{i = 1}^{256} adc [ i ] \cdot ref\_F212 [ i - j ] & ( 2 ) \\ corr\_F424 = {max}_{j = 0 …255} {\sum }_{i = 1}^{256} adc [ i ] \cdot ref\_F424 [ i - j ] & ( 3 )\end{matrix}$$

where ref_A106[i-j], ref_F212[i-j] and ref_F424[i-j] are the reference sequences for A106, F212 and F424, respectively, shifted by j samples. This means that the index ‘j’ specifies a phase shift between the digital envelope of the received signal and the reference sequence.

It should be noted that for the correlation according to equations (1) to (3) the reference sequences may be considered as periodical, i.e. the part of the sequence which is shifted out on one side is periodically supplemented on the other side. It should further be noted that equations (1) to (3) and other correlation approaches may be used, e.g. involving averaging instead of maximization etc.

In a practical implementation, not all the 256 relative phases (as given by the index j) have to be considered in equations (1)-(3). This means that the maximum is not necessarily taken over the whole length of the digital envelope (256 samples in this example) but only over some phase shifts, e.g. over three to ten phase shifts, which are for example evenly distributed over 0 . . . 255, e.g. phase shifts 0, 64, 128, 192.

Based on equations (1)-(3), the correlator 411 may decide which communication type was received according to the following:

| If (corr_A106 > max{corr_F212,corr_F424}) then | |
|---|---|
| Detected type = Type A | |
| Else If (corr_F212 ≈ corr_F424) then | |
| Detected type = Type B | (4) |
| Else If (corr_F212 > corr_F424) then | |
| Detected type = Type FeliCa 212 | |
| Else | |
| Detected type = Type FeliCa 424 | |
| End | |

It should be noted that in the above example no correlation value is determined for ISO/IEC 14443 Type B. This is because, as illustrated in the second graph 302 of FIG. 3, the waveform for the ISO/IEC Type B polling command is substantially constant. Therefore, instead of comparing a correlation value for ISO/IEC Type B with correlation values for ISO/IEC Type A and FeliCa, the correlator 411 decides that a radio signal according to ISO/IEC Type B has been received if the correlation value for FeliCa 212 corr F212 and the correlation value for FeliCa 424 corr_424 are within a certain range from each other (and the correlation value for ISO/IEC 14443 Type A communication is not higher). For example, the range may for example be that the correlation values differ by at most 1%. A corresponding suitable limit (e.g. 0.5%, 1%, or 2%) may for example be set based on experimental study. For example, the correlator decides that a radio signal according to ISO/IEC Type B has been received if the absolute value of the difference between the correlation value for FeliCa 212 corr_F212 and the correlation value for FeliCa 424 corr_424 is smaller than 1% of the correlation value for FeliCa 212 corr_F212.

If, in contrast, a correlation value is higher than the others by more than that threshold or range, it may be decided that the radio signal has been transmitted according to the radio communication technology corresponding to the signal value sequence for which that correlation value has been determined. In other words, correlation values differing by less than such a predetermine threshold or range are considered to be similar (in the sense of ‘≈’) while in case of correlation values whose difference is larger than the threshold one correlation value is considered to be smaller or larger than the other (i.e. ‘<’ or ‘>’).

Once the communication type is detected (e.g. at the end of the first etu at 106 kbaud/s), the data recovery module 410 starts data recovery including demodulation and decoding (with the right configuration based on the decision by the correlator 411) and the rest of the radio signal (e.g. rest of the radio frame) is received (e.g. without further involvement by the correlator 411).

For ISO/IEC 14443 Type A and Type B communication, the data recovery module 410 may consider the data received during the first etu. For FeliCa, the data recovery module 410 may ignore those data since the rest of the run-in pattern is typically long enough to synchronize the data recovery algorithm.

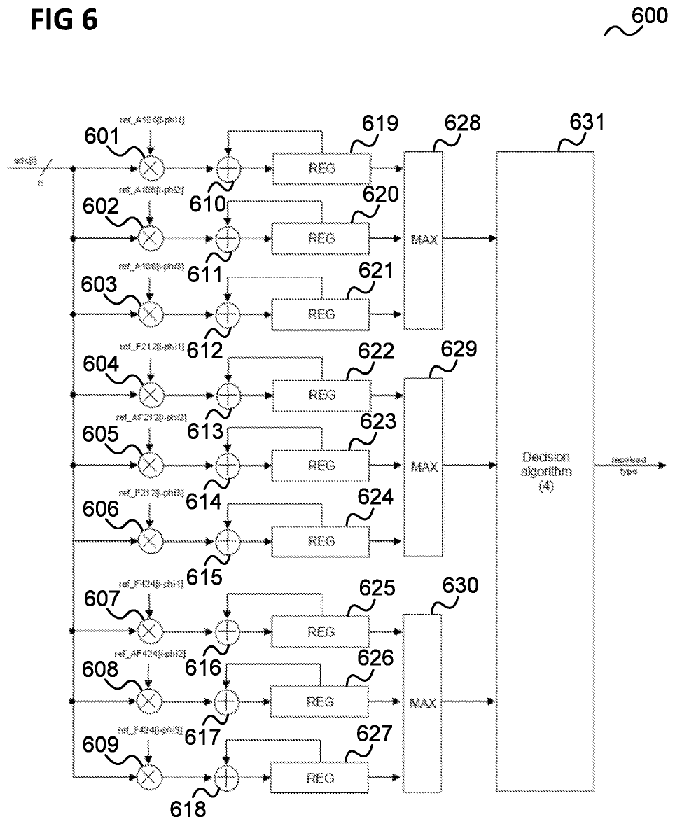

An exemplary implementation of the correlator 411 is described in the following with reference to FIG. 6.

FIG. 6 shows a correlator 600 according to an embodiment.

As mentioned above, in a practical implementation, not all the 256 relative phases (i.e. phase shifts as given by the index j) have to be considered in equations (1)-(3). In the implementation example of FIG. 6, the maximum of equations (1)-(3) is calculated over only three different phase shifts phi1, phi2, phi3. It should be noted that how many and which phase shifts are used may be selected based on a trade-off between power and detection accuracy. For example, a minimum number of phase shifts is used that allows achieving a certain detection accuracy. This may depend on the waveform (e.g. on the command).

For example for A106, phi1=0, phi2=20, phi3=40 and a pause length of 80 samples may be used (see the first 80 samples in FIG. 5). For F212, for example phi1=0, phi2=32 and phi3=64 may be used. For F424, for example phi1=0, phi2=16, phi3=32 may be used.

The correlator 600 receives the digital envelope adc[i] as input.

The digital envelope is fed to a first multiplier 601 configured to multiply the digital envelope (signal value per signal value) with the reference signal for ISO/IEC 14443 Type A communication shifted by the first phase phi1, a second multiplier 602 configured to multiply the digital envelope (signal value per signal value) with the reference signal for ISO/IEC 14443 Type A communication shifted by the second phase phi2, a third multiplier 603 configured to multiply the digital envelope (signal value per signal value) with the reference signal for ISO/IEC 14443

Type A communication shifted by the third phase phi3, a fourth multiplier 604 configured to multiply the digital envelope (signal value per signal value) with the reference signal for FeliCa 212 communication shifted by the first phase phi1, a fifth multiplier 605 configured to multiply the digital envelope (signal value per signal value) with the reference signal for FeliCa 212 communication shifted by the second phase phi2, a sixth multiplier 606 configured to multiply the digital envelope (signal value per signal value) with the reference signal for FeliCa 212 communication shifted by the third phase phi3, a seventh multiplier 607 configured to multiply the digital envelope (signal value per signal value) with the reference signal for FeliCa 424 communication shifted by the first phase phi1, an eighth multiplier 608 configured to multiply the digital envelope (signal value per signal value) with the reference signal for FeliCa 424 communication shifted by the second phase phi2 and a ninth multiplier 609 configured to multiply the digital envelope (signal value per signal value) with the reference signal for FeliCa 424 communication shifted by the third phase phi3.

For each multiplier 601-609 a respective adder 610-618 and a respective register 619-627 are arranged at the output of the multiplier 601-609 which are configured to add up the output values of the multiplier 601-609 to generate an aggregated correlation value for each phase (according to the summing operation in equations (1) to (3)).

A first maximizer 628 is configured to determine the maximum of the aggregated correlation values for ISO/IEC 14443 Type A communication among the three phases, a second maximizer 629 is configured to determine the maximum of the aggregated correlation values for FeliCa 212 communication among the three phases and a third maximizer 630 is configured to determine the maximum of the aggregated correlation values for FeliCa 212 communication among the three phases (according to the max operation in equations (1) to (3)).

The outputs of the maximizers 628, 629, 630 are fed to a decision block 631 which decides which communication type has been received, e.g. according to (4) described above.

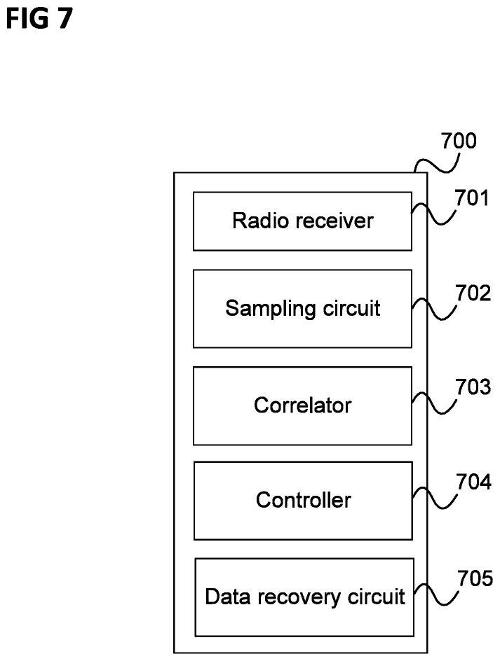

In summary, according to various embodiments, a communication device is provided as illustrated in FIG. 7.

FIG. 7 shows a communication device 700 according to an embodiment.

The communication device 700 includes a radio receiver 701 configured to receive a radio signal and a sampling circuit 702 configured to sample the radio signal to generate a sequence of digital sampling values of the radio signal.

The communication device 700 further includes a correlator 703 configured to correlate the sequence of digital sampling values with each of a plurality of sequences of reference signal values, wherein each sequence of reference signal values corresponds with a respective radio communication technology of a plurality of radio communication technologies.

Further, the communication device 700 includes a controller 704 configured to select a radio communication technology of the plurality of radio communication technologies based on the results of the correlation.

The communication device 700 further includes a data recovery circuit 705 configured to demodulate and decode the radio signal according to the selected radio communication technology.

According to various embodiments, in other words, a communication device performs a pattern matching between a received radio signal and reference signal waveforms for possible (i.e. candidate) communication technologies (i.e. possible radio communication types) according to which the radio signal has been transmitted. The communication device performs this pattern matching by means of a correlation between sampling values (e.g. a digital envelope) of the radio signal and reference signal values for each of the possible communication technologies (e.g. all communication technologies supported by the communication device). The controller may take its decision about the radio communication technology according to the criterion that the higher the correlation (e.g. in terms of a correlation result in form of a correlation value) of a reference sequence is, the more likely it is that the radio signal was transmitted according to the radio communication technology corresponding to the reference sequence. The radio communication technology selected by the controller, i.e. the radio communication technology for which the controller decides that it is the one according to which the radio signal has been transmitted, defines the demodulation and decoding performed by the data recovery circuit (or module).

The controller may for example operate according to an algorithm to automatically detect one out of four possible communication types for proximity cards according to the ISO14443 and FeliCa standards. The controller may for example use the correlation between the first N samples (e.g. N=256) of the digitalized analog envelope and squared two-value (binary) reference sequences.

It should be noted that sampling the radio signal may mean rectifying the radio signal and forming a digital envelope of the radio signal and taking values of the digital envelope of the radio signal. Thus, “sampling” may be understood as determining digital values represented by (sequential) amplitudes of the radio signal. The sampling can thus be a sampling of the radio signal at its peaks (and taking absolute values or rectifying the radio signal first and then sampling it at its peaks).

Various components of the communication device (such as in particular the correlator, the controller and the data recovery circuit) may for example be implemented by one or more circuits. In an embodiment, a “circuit” may be understood as any kind of a logic implementing entity, which may be special purpose circuitry or also if applicable a processor executing software stored in a memory, firmware, or any combination thereof. Thus, in an embodiment, a “circuit” may be a hard-wired logic circuit or a programmable logic circuit such as a programmable processor.

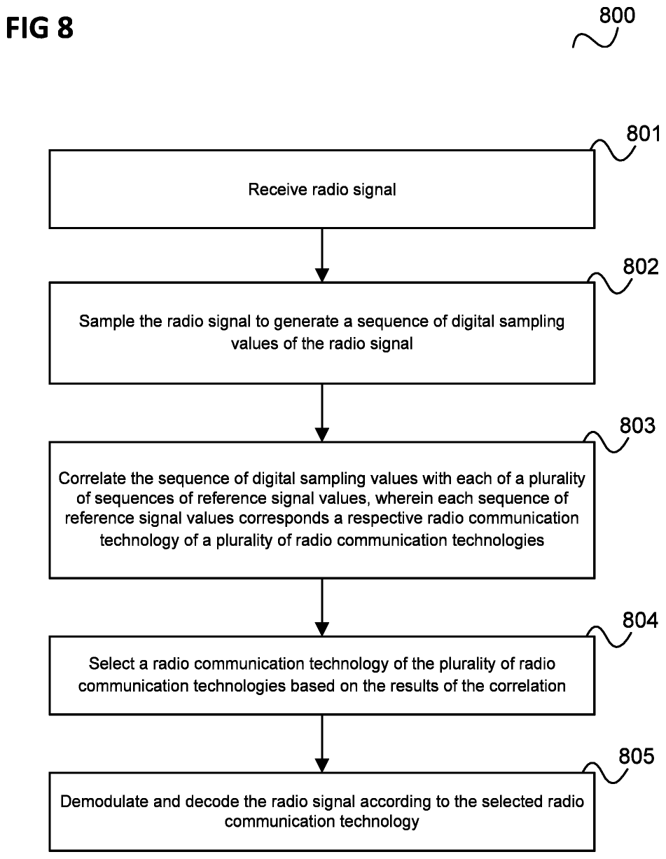

According to various embodiments, a method as illustrated in FIG. 8 is performed.

FIG. 8 shows a flow diagram 800 illustrating a method for receiving data via a radio signal.

In 801, a radio signal is received.

In 802, the radio signal is sampled to generate a sequence of digital sampling values of the radio signal.

In 803, the sequence of digital sampling values is correlated with each of a plurality of sequences of reference signal values, wherein each sequence of reference signal values corresponds with a respective radio communication technology of a plurality of radio communication technologies.

In 804, a radio communication technology of the plurality of radio communication technologies is selected based on the results of the correlation.

In 805, the radio signal is demodulated and decoded according to the selected radio communication technology.

Various Examples are described in the following:

Example 1 is a communication device as illustrated in FIG. 7.

Example 2 is the communication device according to Example 1, wherein the sampling circuit includes a rectifier configured to rectify the radio signal, a peak detector configured to generate an analog envelope of the radio signal and an analog-to-digital converter configured to generate a digital envelope of the radio signal, wherein the sequence of digital sampling values of the radio signal are sequential values of the digital envelope of the radio signal.

Example 3 is the communication device according to Example 1 or 2, wherein the correlator is configured to correlate the sequence of digital sampling values with each sequence of reference signal values for each of a plurality of different phase shifts between the sequence of digital sampling values and the sequence of reference signal values.

Example 4 is the communication device according to Example 3, wherein the correlator is configured to determine a value of the correlation between the sequence of digital sampling values and each sequence of reference signal values by taking the maximum of the correlation between the sequence of digital sampling values and the sequence of reference signal values over the plurality of different phase shifts.

Example 5 is the communication device according to any one of Examples 1 to 4, wherein the correlator is configured to output a correlation value as result of the correlation of the sequence of digital sampling values with a sequence of reference signal values.

Example 6 is the communication device according to any one of Examples 1 to 5, wherein the controller is configured to compare the results of the correlation among the plurality of sequences of reference signal values and is configured to select a radio communication technology of the plurality of radio communication technologies based on the result of the comparison.

Example 7 is the communication device according to any one of Examples 1 to 6, wherein the controller is configured to, if a sequence of reference values has a correlation with the sequence of digital sampling values higher by a predetermined threshold than the other sequence of reference values, select the radio communication technology corresponding to the sequence of reference values.

Example 8 is the communication device according to any one of Examples 1 to 7, wherein the radio communication technologies include at least two of ISO/IEC 14443 Type A, ISO/IEC 14443 Type B, FeliCa 212 and FeliCa 424.

Example 9 is the communication device according to any one of Examples 1 to 8, wherein the radio communication technologies include at least ISO/IEC 14443 Type B, FeliCa 212 and FeliCa 424 and the controller is configured to select ISO/IEC 14443 Type B if the correlation of the sequence of reference signal values corresponding to FeliCa 212 and the sequence of reference signal values corresponding to FeliCa 424 differs by less than a predetermined threshold.

Example 10 is the communication device according to any one of Examples 1 to 9, wherein the radio communication technologies are near-field radio communication technologies.

Example 11 is the communication device according to any one of Examples 1 to 10, wherein each sequence of reference signal values includes ideal signal values for the radio communication technology to which it corresponds.

Example 12 is the communication device according to any one of Examples 1 to 11, wherein each sequence of reference signal values includes ideal signal values of a polling command for the radio communication technology to which it corresponds.

Example 13 is a method for receiving data via a radio signal as illustrated in FIG. 8.

Example 14 is the method according to Example 13, including rectifying the radio signal, generating an analog envelope of the radio signal and generating a digital envelope of the radio signal, wherein the sequence of digital sampling values of the radio signal are sequential values of the digital envelope of the radio signal.

Example 15 is the method according to Example 13 or 14, including correlating the sequence of digital sampling values with each sequence of reference signal values for each of a plurality of different phase shifts between the sequence of digital sampling values and the sequence of reference signal values.

Example 16 is the method according to Example 15, including determining a value of the correlation between the sequence of digital sampling values and each sequence of reference signal values by taking the maximum of the correlation between the sequence of digital sampling values and the sequence of reference signal values over the plurality of different phase shifts.

Example 17 is the method according to any one of Examples 13 to 16, including outputting a correlation value as result of the correlation of the sequence of digital sampling values with a sequence of reference signal values.

Example 18 is the method according to any one of Examples 13 to 17, including comparing the results of the correlation among the plurality of sequences of reference signal values and selecting a radio communication technology of the plurality of radio communication technologies based on the result of the comparison.

Example 19 is the method according to any one of Examples 13 to 18, including, if a sequence of reference values has a correlation with the sequence of digital sampling values higher by a predetermined threshold than the other sequence of reference values, selecting the radio communication technology corresponding to the sequence of reference values.

Example 20 is the method according to any one of Examples 13 to 19, wherein the radio communication technologies include at least two of ISO/IEC 14443 Type A, ISO/IEC 14443 Type B, FeliCa 212 and FeliCa 424.

Example 21 is the method according to any one of Examples 13 to 20, wherein the radio communication technologies include at least ISO/IEC 14443 Type B, FeliCa 212 and FeliCa 424 and the method includes selecting ISO/IEC 14443 Type B if the correlation of the sequence of reference signal values corresponding to FeliCa 212 and the sequence of reference signal values corresponding to FeliCa 424 differs by less than a predetermined threshold.

Example 22 is the method according to any one of Examples 13 to 21, wherein the radio communication technologies are near-field radio communication technologies.

Example 23 is the method according to any one of Examples 13 to 21, wherein each sequence of reference signal values includes ideal signal values for the radio communication technology to which it corresponds.

Example 24 is the method according to any one of Examples 13 to 23, wherein each sequence of reference signal values includes ideal signal values of a polling command for the radio communication technology to which it corresponds.

Example 25 is a communication arrangement including a radio transmitter configured to transmit a radio signal according to a radio communication technology and a communication device according to any one of examples 1 to 12.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

### REFERENCE SIGNS

100 communication arrangement
101 reader
102 chip card
103 reader antenna
104 chip card module
105 chip card antenna
200 communication arrangement
201 reader
202 ASK digital receiver
203 reader antenna
204 resonance circuit
205 antenna
206 capacity
207 rectifier
208 peak detector
209 analog-to-digital converter
210 data recovery module
211 modulated input signal
212 analog envelope
213 digital envelope
301 ISO/IEC 14443 Type A polling command waveform
302 ISO/IEC 14443 Type B polling command waveform
303 FeliCa 212 polling command waveform
304 FeliCa 424 polling command waveform
400 communication arrangement
401 reader
402 ASK digital receiver
403 reader antenna
404 resonance circuit
405 antenna
406 capacity
407 rectifier
408 peak detector
409 analog-to-digital converter
410 data recovery module
411 correlator
501 ISO/IEC 14443 Type A polling command reference sequence
502 FeliCa 212 polling command reference sequence
503 FeliCa 424 polling command reference sequence
600 correlator
601-609 multipliers
610-618 adders
619-627 registers
628-630 maximizer
631 decision block
700 communication device
701 radio receiver
702 sampling circuit
703 correlator
704 controller
705 data recovery circuit
800 flow diagram
801-805 process operations

What is claimed is:

1. A communication device, comprising:
a radio receiver configured to receive a radio signal;
a sampling circuit configured to sample the radio signal to generate a sequence of digital sampling values of the radio signal;
a correlator configured to correlate the sequence of digital sampling values with each of a plurality of sequences of reference signal values, wherein each sequence of reference signal values corresponds with a respective radio communication technology of a plurality of radio communication technologies;
a controller configured to select a radio communication technology of the plurality of radio communication technologies based on the results of the correlation; and
a data recovery circuit configured to demodulate and decode the radio signal according to the selected radio communication technology.

2. The communication device according to claim 1, wherein the sampling circuit comprises a rectifier configured to rectify the radio signal, a peak detector configured to generate an analog envelope of the radio signal, and an analog-to-digital converter configured to generate a digital envelope of the radio signal, wherein the sequence of digital sampling values of the radio signal are sequential values of the digital envelope of the radio signal.

3. The communication device according to claim 1, wherein the correlator is configured to correlate the sequence of digital sampling values with each sequence of reference signal values for each of a plurality of different phase shifts between the sequence of digital sampling values and the sequence of reference signal values.

4. The communication device according to claim 3, wherein the correlator is configured to determine a value of the correlation between the sequence of digital sampling values and each sequence of reference signal values by taking the maximum of the correlation between the sequence of digital sampling values and the sequence of reference signal values over the plurality of different phase shifts.

5. The communication device according to claim 1, wherein the correlator is configured to output a correlation value as a result of the correlation of the sequence of digital sampling values with a sequence of reference signal values.

6. The communication device according to claim 1, wherein the controller is configured to compare the results of the correlation among the plurality of sequences of reference signal values, and is configured to select a radio communication technology of the plurality of radio communication technologies based on the result of the comparison.

7. The communication device according to claim 1, wherein the controller is configured to, if a sequence of reference values has a correlation with the sequence of digital sampling values higher by a predetermined threshold than the other sequence of reference values, select the radio communication technology corresponding to the sequence of reference values.

8. The communication device according to claim 1, wherein the radio communication technologies comprise at least two of ISO/IEC 14443 Type A, ISO/IEC 14443 Type B, FeliCa 212 and FeliCa 424.

9. The communication device according to claim 1, wherein the radio communication technologies comprise at least ISO/IEC 14443 Type B, FeliCa 212 and FeliCa 424, and the controller is configured to select ISO/IEC 14443 Type B if the correlation of the sequence of reference signal values corresponding to FeliCa 212 and the sequence of reference signal values corresponding to FeliCa 424 differs by less than a predetermined threshold.

10. The communication device according to claim 1, wherein the radio communication technologies are near-field radio communication technologies.

11. The communication device according to claim 1, wherein each sequence of reference signal values includes ideal signal values for the radio communication technology to which it corresponds.

12. The communication device according to claim 1, wherein each sequence of reference signal values includes ideal signal values of a polling command for the radio communication technology to which it corresponds.

13. A method for receiving data via a radio signal, comprising:
receiving a radio signal;
sampling the radio signal to generate a sequence of digital sampling values of the radio signal;
correlating the sequence of digital sampling values with each of a plurality of sequences of reference signal values, wherein each sequence of reference signal values corresponds with a respective radio communication technology of a plurality of radio communication technologies;
selecting a radio communication technology of the plurality of radio communication technologies based on the results of the correlation; and
demodulating and decoding the radio signal according to the selected radio communication technology.

14. A communication arrangement, comprising:
a radio transmitter configured to transmit a radio signal according to a radio communication technology; and
a communication device comprising:
a radio receiver configured to receive the radio signal;
a sampling circuit configured to sample the radio signal to generate a sequence of digital sampling values of the radio signal;
a correlator configured to correlate the sequence of digital sampling values with each of a plurality of sequences of reference signal values, wherein each sequence of reference signal values corresponds a respective radio communication technology of a plurality of radio communication technologies;
a controller configured to select a radio communication technology of the plurality of radio communication technologies based on the results of the correlation; and
a data recovery circuit configured to demodulate and decode the radio signal according to the selected radio communication technology.
